(19) United States
(12) Patent Application Publication
(10) Pub. No.: US 2021/0199533 A1
(43) Pub. Date: Jul. 1, 2021

(54) POSITIONING METHOD FOR SPECIFIC SOUND SOURCE

(71) Applicant: Industrial Technology Research Institute, Hsinchu (TW)

(72) Inventors: Wei-Yi Chuang, Hsinchu City (TW); Yao-Long Tsai, Kaohsiung City (TW)

(73) Assignee: Industrial Technology Research Institute, Hsinchu (TW)

(21) Appl. No.: 16/731,039

(22) Filed: Dec. 31, 2019

(51) Int. Cl. G01M 3/24; G01H 1/06

(52) U.S. Cl. CPC G01M 3/243; G01H 1/06

(57) ABSTRACT

A positioning method for a specific sound source is provided. An acoustic signal in each of multiple positions of on a preset path is respectively collected through a sensor. A pre-processing is performed on the acoustic signal to obtain multiple signal features. The signal features are used as an input of a deep learning model. The deep learning model is used for a signal recognition to obtain multiple specific sound signals of each position. An autocorrelation function operation is performed on the specific sound signals obtained at a same position to obtain multiple autocorrelation coefficients. A representative value among the autocorrelation coefficients is selected as a representative coefficient corresponding to each position. A specific sound source position is found according to the representative coefficient of each position.

### BACKGROUND

### Technical Field

The disclosure relates to a positioning method for a specific sound source.

### Description of Related Art

At present, most of the methods for detecting the occurrence point of a specific sound source need to be carried out by the inspector gradually using a handheld sensing equipment to perform fixed-point sensing. Then, the experience of the inspector is used to recognize whether the detected signal is a specific sound. Once it is confirmed that the specific sound is detected, the inspector then judges whether the position is the position where the specific sound is emitted according to the experience of the inspector. However, recognition by the user is easily affected by factors such as subjective consciousness, external environment, etc., causing the accuracy rate of the recognition to be poor.

### SUMMARY

The disclosure provides a positioning method for a specific sound source including the following steps. An acoustic signal in each of multiple positions on a preset path is respectively collected through a sensor. A pre-processing is performed on the acoustic signals to obtain multiple signal features. The signal feature is used as an input of a deep learning model and the deep learning model is used to perform a signal recognition to obtain multiple specific sound signals of each position. An autocorrelation function operation is performed on the specific sound signals obtained at the same position to obtain multiple autocorrelation coefficients. A representative value is selected among the autocorrelation coefficients as a representative coefficient corresponding to each position. A position of the specific sound source is found according to the representative coefficient of each position.

### BRIEF DESCRIPTION OF THE DRAWINGS

FIG. 1A is a block diagram of a positioning device of a specific sound source according to an embodiment of the disclosure.

FIG. 1B is a block diagram of a positioning device of a specific sound source according to another embodiment of the disclosure.

FIG. 2 is a flowchart of a positioning method for a specific sound source according to an embodiment of the disclosure.

FIG. 3 is a schematic diagram of detecting a specific sound source according to an embodiment of the disclosure.

### DETAILED DESCRIPTION OF DISCLOSED EMBODIMENTS

The disclosure provides a positioning method for a specific sound source, which can effectively improve the accuracy rate of recognition.

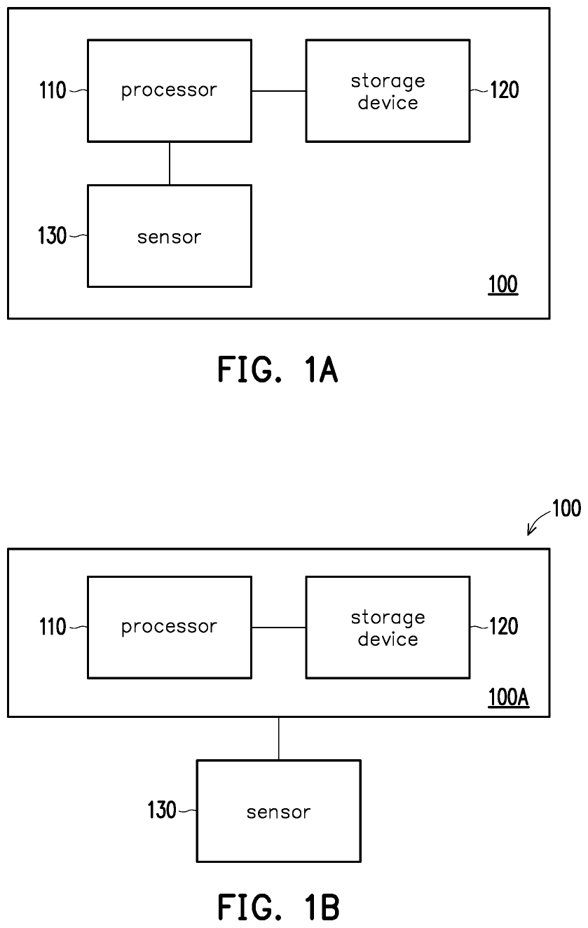

FIG. 1A is a block diagram of a positioning device of a specific sound source according to an embodiment of the disclosure. FIG. 1B is a block diagram of a positioning device of a specific sound source according to another embodiment of the disclosure.

In FIG. 1A, a positioning device 100 includes a processor 110, a storage device 120, and a sensor 130. The processor 110 is coupled to the storage device 120 and the sensor 130. The processor 110 is, for example, a central processing unit (CPU), a physical processing unit (PPU), a programmable microprocessor, an embedded control chip, a digital signal processor (DSP), an application specific integrated circuits (ASIC), or other similar devices.

The storage device 120 is, for example, any type of fixed or movable random access memory (RAM), read-only memory (ROM), flash memory, hard disk, other similar devices, or a combination of these devices. One or more code segments is stored in the storage device 120. After the code segments are installed, the processor 110 executes the code segments to implement a positioning method for a specific sound source to be described later.

The sensor 130 is configured to collect an acoustic signal in each of multiple positions on a preset path. In an embodiment, only one sensor 130 needs to be disposed, but is not limited thereto. The multiple positions are set in advance on the preset path. The positioning device 100 moves along the preset path from an initial position. Each time the positioning device 100 moves to the set position, the positioning device 100 collects the acoustic signal of the position through the sensor 130. Next, the processor 110 finds the position where the specific sound is emitted (referred hereinafter as the specific source position) through the acoustic signal.

In another embodiment, as shown in FIG. 1B, a positioning device 100 includes a host 100A and a sensor 130 disposed independently. In the embodiment, a processor 110 and a storage device 120 are disposed in the same host 100A, and the sensor 130 is a component disposed independently. After collecting an acoustic signal, the sensor 130 transmits the acoustic signal to the host 100A through a wired or wireless transmission method. Here, one or more code segments are stored in the storage device 120. After the code segments are installed, the processor 110 executes the code segments to implement a positioning method for a specific sound source to be described later.

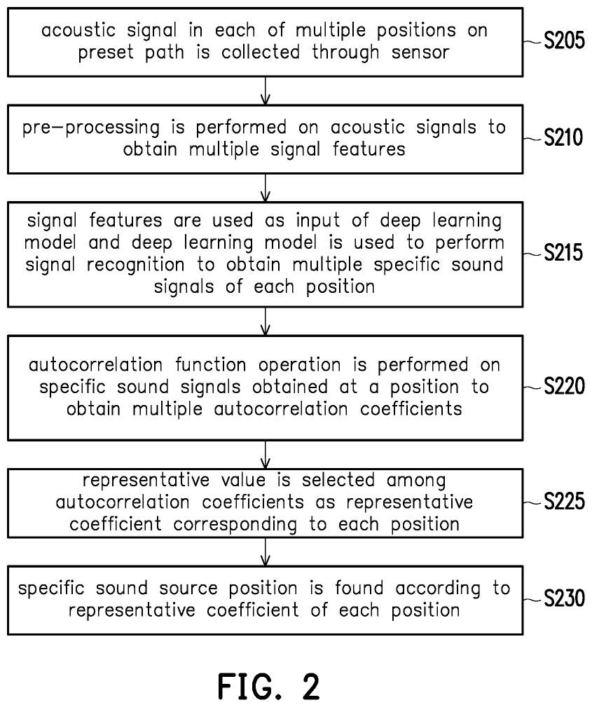

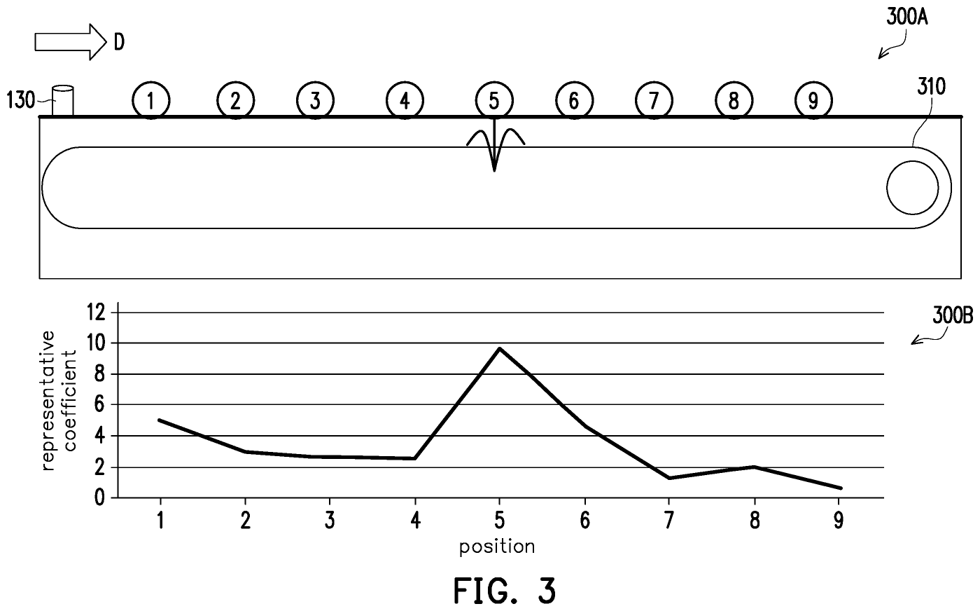

FIG. 2 is a flowchart of a positioning method for a specific sound source according to an embodiment of the disclosure. FIG. 3 is a schematic diagram of detecting a specific sound source according to an embodiment of the disclosure. In FIG. 3, the schematic diagram 300A on top is used to represent a sensor 130 collecting acoustic signals in multiple positions 1 to 9 on a preset path 310, and the curve diagram 300B below represents a curve diagram obtained based on representative coefficients corresponding to the positions 1 to 9.

Referring to FIG. 2 and FIG. 3, in Step S205, the acoustic signal in each of the multiple positions 1 to 9 on the preset path 310 is collected through the sensor 130. That is, when the sensor 130 moves to the position 1, the sensor 130 stops to perform sampling to collect the acoustic signal at the position 1. Next, the sensor 130 moves to the position 2 and stops to perform sampling to collect the acoustic signal at the position 2. The acoustic signals at the positions 3 to 9 are collected by analogy.

Next, in Step S210, a pre-processing is performed on the acoustic signals to obtain multiple signal features. The processor 110 performs the pre-processing on the acoustic signals collected in each position. In an embodiment, the processor 110 performs the Mel Frequency Cepstrum (MFC) calculation on the acoustic signals, and obtains an MFC coefficient, a first-order differential MFC coefficient, and a second-order differential MFC coefficient, which are used as the signal features of the acoustic signals.

Thereafter, in Step S215, the processor 110 uses the signal features as an input of a deep learning model and uses the deep learning model to perform a signal recognition to obtain multiple specific sound signals of each position. The deep learning model is, for example, a convolutional neural network (CNN) model. The signal features captured in Step S210 are used as the input of the CNN model, and an output result of the CNN model is the recognition result.

The sensor 110 obtains multiple sampling signals based on a sampling frequency and a sampling period, and uses the sampling signals as the acoustic signals. For example, the sampling frequency of the sensor 130 is 8 KHz, the sampling period is 1 second, and the sampling number is 185. That is, the acoustic signals include 185 sampling signals. After performing Steps S210 and S215, sampling signals belong to a specific sound in the 185 sampling signals are determined, the sampling signals are used as specific sound signals, and then an autocorrelation function operation (details to follow) is performed.

The type of the specific sound signal is, for example, water leakage sound, traffic sound, electrical sound, gas leakage sound, or mechanical operation sound, but is not limited thereto. In an embodiment, during the training process, the CNN model is trained using the signal features, such as water leakage sound, traffic sound, electrical sound, gas leakage sound, mechanical operation sound, etc. after being calculated by the MFC. As such, after the signal features are inputted to the CNN model, the CNN model may be used to recognize the signal features as water leakage sound, traffic sound, electrical sound, gas leakage sound, or mechanical operation sound.

For example, the recognition result shown in Table 1 is obtained by respectively inputting the signal features of the acoustic signals of electrical sound, traffic sound, and water leakage sound, and through recognizing by the CNN model.

TABLE 1

Predicted type

| | Traffic | Electrical | Water leakage |
|---|---|---|---|
| Actual type | sound | sound | sound |
| Traffic sound | 53 | 0 | 0 |
| Electrical sound | 0 | 66 | 0 |
| Water leakage sound | 0 | 2 | 64 |

In Table 1, there are 53 acoustic signals whose actual type is traffic sound and 53 acoustic signals whose predicted type as obtained through the CNN model is traffic sound. There are 66 acoustic signals whose actual type is electrical sound and 66 acoustic signals whose predicted type as obtained through the CNN model is electrical sound. There are 66 acoustic signals whose actual type is leaking sound and 64 acoustic signals whose predicted type as obtained through the CNN model is leaking sound with 2 acoustic signals being misjudged as electrical sound. It can be known that, in the embodiment, the accuracy rate of using the CNN model to recognize the signal features of the acoustic signals may reach 98.9%.

The deep learning model is used to determine whether the sound signal belongs to the specific sound. When the sound signal is determined to be the specific sound, the sampling signal is used as the specific sound signal. In an embodiment, the main purpose is to detect the water leakage position. At this time, the sound signal recognized as the water leakage sound is selected as the specific sound signal. Thereafter, in Step S220, the processor 110 performs an autocorrelation function operation on multiple specific sound signals obtained at a position to obtain multiple autocorrelation coefficients. Thereafter, in Step S225, the processor 110 selects a representative value among the autocorrelation coefficients as a representative coefficient corresponding to each position. The processor 110 uses the autocorrelation coefficients of the multiple specific sound signals sampled at the same position to quantify the strength of a periodic signal. Specifically, in an embodiment, the representative value is a maximum value in the autocorrelation coefficients, that is, the maximum value is taken from the multiple autocorrelation coefficients of the multiple specific sound signals sampled at the same position as the representative coefficient of the position, but is not limited thereto.

In the example of FIG. 3, it is described that sounds emitted from positions 1 to 9 disposed along a moving direction D on a preset path 300 belong to a specific sound. First, when the sensor 130 moves to the position 1 along the moving direction D. The processor 110 on the position 1 may determine that the acoustic signals collected by the sensor 130 belong to a specific sound through the CNN model. Next, an autocorrelation function operation is performed on the multiple specific sound signals sampled at the position 1, thereby obtaining multiple autocorrelation coefficients corresponding to the position 1. After that, a maximum value is taken from the multiple autocorrelation coefficients corresponding to the position 1 as a representative coefficient corresponding to the position 1. Next, the sensor 130 moves to the position 2 along the moving direction D. The processor 110 may determine that the acoustic signals collected by the sensor 130 belong to a specific sound through the CNN model. Next, an autocorrelation function operation is performed on multiple specific sound signals sampled at the position 2 to obtain multiple autocorrelation coefficients corresponding to the position 2. After that, a maximum value is taken from the multiple autocorrelation coefficients corresponding to the position 2 as a representative coefficient corresponding to the position 2. By analogy, when the sensor 130 gradually moves to the positions 3 to 9, a representative coefficient corresponding to the positions 3 to 9 may be calculated.

Then, in Step S230, the processor 110 finds a specific sound source position according to the representative coefficient of each position. Specifically, a maximum value is found among the representative coefficients of the position, and the position corresponding to the representative coefficient of the maximum value is determined as the specific sound source position. In terms of FIG. 3, the position 5 is determined as the specific sound source position.

In another embodiment, the processor 110 may also calculate a difference value between two representative coefficients of two adjacent positions. When the difference value is greater than a threshold value, the position corresponding to the larger one of the two representative coefficients is determined as the specific sound source position. That is, all of the acoustic signals measured in a specific range (for example, the positions 1 to 9 shown in FIG. 3) are determined as the specific sound signals, the representative coefficients of two adjacent positions are compared with each other until the difference value between the two representative coefficients is greater than the threshold value, and the position where the largest representative coefficient is positioned is the specific sound source position.

The positioning method for the specific sound source may be applied to the positioning of water leakage sound, traffic sound, electrical sound, gas leakage sound, or mechanical operation sound, and is not limited thereto. For example, in the positioning of water leakage sound, the sound features are used for recognition. When a specific event (leakage in underground pipeline) occurs, a specific sound is generated due to the pressure change of the substance (liquid or gas) in the pipe.

Based on the above, the measured acoustic signals are identified in real time through the deep learning model, and the positioning of the position where the signals occur is performed by a signal correlation analysis method. The specific event may be diagnosed in real time by measuring sound and the position where the event occurs is positioned to reduce event processing time and improve event processing efficiency.

In summary, the disclosure only needs to use a single sensor to measure the acoustic signals at multiple positions, the deep learning model is collocated to recognize the measured acoustic signals in real time, and the characteristic of the signals at the source where the specific sound is emitted having strong periodicity is used to calculate the autocorrelation coefficients of adjacent positions, so as to find the specific sound source position. As such, only a single sensor is needed to find the position (specific sound source position) where the specific sound is emitted. In addition, by measuring the acoustic signals, it is possible to diagnose whether a specific event occurs in real time and to position the position where the specific event occurs, so as to reduce event processing time and improve event processing efficiency.

What is claimed is:

1. A positioning method for a specific sound source, comprising:
collecting respectively, through a sensor, an acoustic signal in each of a plurality of positions on a preset path;
performing a pre-processing on the acoustic signal to obtain a plurality of signal features;
using the plurality of signal features as an input of a deep learning model and using the deep learning model to perform a signal recognition to obtain a plurality of specific sound signals of each of the plurality of the positions;
performing an autocorrelation function operation on the plurality of specific sound signals obtained at a same position to obtain a plurality of autocorrelation coefficients;
selecting a representative value among the plurality of autocorrelation coefficients as a representative coefficient corresponding to each of the plurality of positions; and
finding a specific sound source position according to the representative coefficient of each of the plurality of positions.

2. The positioning method for a specific sound source according to claim 1,
wherein the step of performing the pre-processing on the acoustic signal to obtain the plurality of signal features comprises:
performing a Mel Frequency Cepstrum (MFC) calculation on the acoustic signal to obtain an MFC coefficient, a first-order differential MFC coefficient, and a second-order differential MFC coefficient as the plurality of signal features.

3. The positioning method for a specific sound source according to claim 1, wherein the step of finding the specific sound source position according to the representative coefficient of each of the plurality of positions comprises:
finding a maximum value among the representative coefficients of each of the plurality of positions; and
determining a position corresponding to the representative coefficient of the maximum value as the specific sound source position.

4. The positioning method for a specific sound source according to claim 1, wherein the step of finding the specific sound source position according to the representative coefficient of each of the plurality of positions comprises:
calculating a difference value between two of the representative coefficients of two adjacent positions, wherein when the difference value is greater than a threshold value, a position corresponding to a larger representative coefficient of the two representative coefficients is determined as the specific sound source position.

5. The positioning method for a specific sound source according to claim 1,
wherein the deep learning model is a convolutional neural network model.

6. The positioning method for a specific sound source according to claim 1,
wherein the sensor obtains a plurality of sampling signals based on a sampling frequency and a sampling period, and the plurality of sampling signals are used as the acoustic signal.

7. The positioning method for a specific sound source according to claim 6, wherein the step of using the deep learning model to perform the signal recognition comprises:
using the deep learning model to determine whether the acoustic signal belongs to a specific sound; and
using the plurality of sampling signals as the plurality of specific sound signals when determining that the acoustic signal belongs to the specific sound.

8. The positioning method for a specific sound source according to claim 1, wherein the representative value is a maximum value of the plurality of autocorrelation coefficients.
